(19) United States
(12) Patent Application Publication
(10) Pub. No.: US 2024/0415275 A1
(43) Pub. Date: Dec. 19, 2024

(54) Combination Toothbrush and Dental Floss Dispenser

(71) Applicant: Gerald Hill, Rockport, ME (US)

(72) Inventor: Gerald Hill, Rockport, ME (US)

(21) Appl. No.: 17/100,354

(22) Filed: Nov. 20, 2020

(51) Int. Cl. A46B 15/00; A46B 9/04; A61C 15/04

(52) U.S. Cl. CPC A46B 15/0073; A46B 9/04; A46B 15/0065; A61C 15/043; A46B 2200/1066

(57) ABSTRACT

An oral hygiene device comprising a brush head portion comprising a brush head having a plurality of bristles and a longitudinal extension connecting the brush head to a base portion having an insertable portion, the insertable portion having a smaller diameter than the base portion. A floss dispenser portion having an inner cavity operable to receive a floss coil. The inner cavity extending through an upper end of the floss dispenser portion, operable to receive the insertable portion. An aperture proximal the upper end of the floss dispenser portion, extending through the floss dispenser portion to create a passage through which a length of floss may extend. Additionally, a method of providing oral care, comprising providing the oral hygiene device described above, pulling the length of floss through the aperture, wrapping the length of floss around the cleat, pulling the length of floss through the keyhole slot, and creating tension in the length of floss. Then, wrapping the length of floss around a user's finger and flossing.

### CROSS-REFERENCE TO ANY RELATED APPLICATION(S)

None.

### BACKGROUND OF THE INVENTION

### Field of the Invention

The present invention generally relates to an oral hygiene device. More specifically, the present invention relates to an oral hygiene device that combines the function of a toothbrush with a dental floss dispenser and a flossing tool.

### Description of the Prior Art

Oral hygiene devices combining a toothbrush with a dental floss dispenser are generally known. For example, U.S. Pat. Nos. 1,646,082, 7,201,172, and 7,237,560 and U.S. Pat. App. 2003/0188761 disclose toothbrushes that include a supply of dental floss within a handle of the toothbrush, an orifice through which a user can pull the floss, and a cutter to cut a length of floss. When using these devices, a user pulls a length of floss through the orifice, cuts the floss at the desired length, and proceeds to use the floss conventionally by winding each end of the floss around a finger before flossing.

U.S. Pat. App. No. 2009/0188519 discloses a toothbrush that includes a supply of dental floss within the handle, an orifice through which a user can pull the floss, a flossing device, and a cutter. To use the device, a user first pulls the floss through the orifice and threads it through the flossing device. The user then flosses his teeth using the flossing device, and after flossing, the user pulls an additional amount of floss to remove the used portion of floss, thus priming the device for the next use.

The references described above, while functional, present practical problems that must be overcome. A significant issue with flossing is the difficulty of maneuvering the floss within the mouth when the floss is wrapped around a user's fingers. None of the prior devices provide a way to minimize the space utilized within a user's mouth while still providing the flexibility of using one's fingers in a sanitary way. Prior oral hygiene devices disclose toothbrushes that dispense floss and hold the floss at the end of the brush opposite the bristles. Generally, toothbrushes, when not in use, reside in a receptacle where the end of the brush opposite the bristles contacts the receptacle, exposing the end of the brush opposite the bristles to potential contamination. Therefore, a more logical place for the floss dispenser and the floss holder of the toothbrush is away from the end of the brush opposite the bristles. Moreover, because the brush end with bristles already enters an individual's mouth, it is logical to place the floss holder at the end with bristles. There exists a need for an oral hygiene device comprising a toothbrush and a dental floss dispenser that provides a more comfortable, convenient, efficient, and sanitary flossing experience.

### Statement of the Objects of the Invention

Brushing and flossing teeth on a daily basis is important to preserve good oral hygiene and prevent oral medical conditions, such as cavities and gingivitis. Oral hygiene devices for both brushing and flossing are replaced frequently, leading to a large carbon footprint. One object of the present invention is an oral hygiene device that preserves good oral hygiene and prevents oral medical conditions, such as cavities and gingivitis. A further object of the present invention is an oral hygiene device comprising a toothbrush and a dental floss dispenser that provides more comfortable, convenient, and efficient oral hygiene maintenance. Another object of the present invention is to provide an oral hygiene device comprising a toothbrush and a dental floss dispenser for efficient oral hygiene maintenance in a sanitary way. One more object of the present invention is to provide an oral hygiene device that minimizes the carbon footprint, overall packaging, and plastic waste associated with oral hygiene maintenance by reducing the raw materials required for manufacturing and distribution. Additional objects and advantages of the present invention will be apparent to those skilled in the art from the description of the invention, taken in conjunction with the attached drawings.

### SUMMARY OF THE INVENTION

An oral hygiene device comprising a brush head portion comprising a brush head having a plurality of bristles and a longitudinal extension connecting the brush head to a base portion having an insertable portion, the insertable portion having a smaller diameter than the base portion. The device includes a floss dispenser portion having an inner cavity operable to receive a floss coil. The inner cavity extending through an upper end of the floss dispenser portion, operable to receive the insertable portion. An aperture proximal the upper end of the floss dispenser portion extends through the floss dispenser portion to create a passage which a length of floss may extend through. Additionally, a method of providing oral care, comprises providing the oral hygiene device described above, pulling the length of floss through the aperture, wrapping the length of floss around a cleat, pulling the length of floss through a keyhole slot, creating tension in the length of floss. Then, wrapping the length of floss around a user's finger and flossing.

### BRIEF DESCRIPTION OF THE DRAWINGS

The present invention will now be discussed in further detail below with reference to the accompanying figures in which:

FIG. 1 illustrates an assembled side view, partly in cross-section, of an oral hygiene device according to the present invention;

FIG. 2 illustrates an assembled rear view, partly in cross-section, of an oral hygiene device according to the present invention;

FIG. 3 illustrates a rear view of a brush head portion of an oral hygiene device according to the present invention;

FIG. 4 illustrates a front view of a brush head portion of an oral hygiene device according to the present invention;

FIG. 5 illustrates a cross-sectional view of a floss dispenser portion of an oral hygiene device according to the present invention;

FIG. 6 illustrates a floss coil of an oral hygiene device according to the present invention;

FIG. 7 illustrates an exploded front view of an oral hygiene device according to the present invention;

FIG. 8 illustrates an exploded rear view of an oral hygiene device according to the present invention;

FIG. 9 illustrates an assembled rear view, partly in cross-section, of an oral hygiene device according to the present invention;

FIG. 10 illustrates an exploded detail view of a floss dispenser portion and a floss coil of an oral hygiene device according to the present invention;

FIGS. 11-12 illustrate a method of using a floss hook to extend a length of a floss coil through an aperture of an oral hygiene device according to the present invention.

### DETAILED DESCRIPTION OF THE ILLUSTRATED EMBODIMENT

While the present invention is susceptible of embodiments in various forms, there is shown in the drawings and will hereinafter be described certain exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects. Also, throughout the description, a user is referenced as a male by using the pronouns “he” or “his”. Use of male pronouns to describe a user is for convenience only as the user can be either male or female.

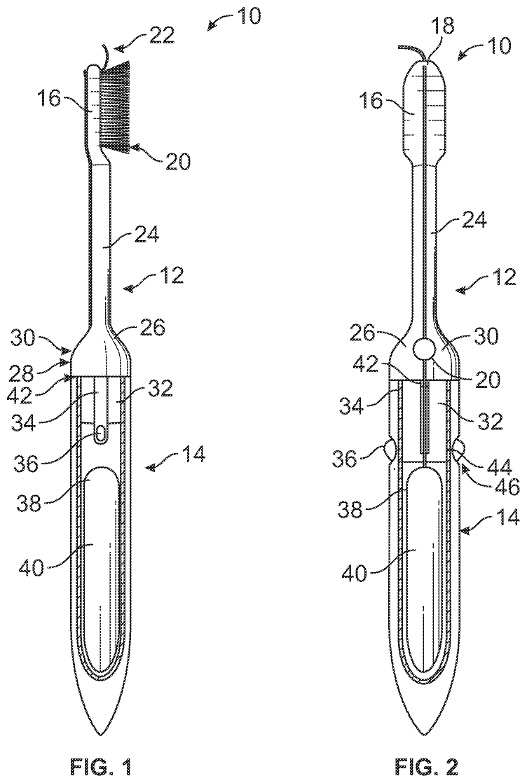

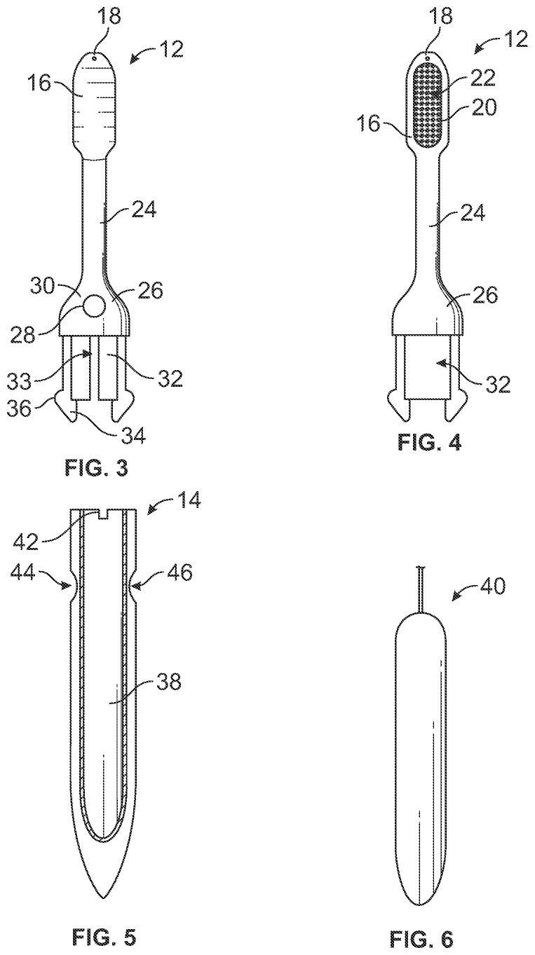

Referring now to FIGS. 1-5, in one embodiment of the invention, an oral hygiene device 10 comprises a brush head portion 12 and a floss dispenser portion 14. The brush head portion 12 further includes a brush head 16 having a keyhole notch 18 and a plurality of bristles 20. The plurality of bristles 20 may be any size, shape, and material conventionally used for cleaning teeth. The brush head 16 may include other ways to clean teeth, such as scrapers, ultrasonic cleaners, or water jets. The plurality of bristles 20 has a plurality of outward-angled bristles 22 angled towards the keyhole slot 18. The brush head portion 12 also includes a lower longitudinal extension 24 connecting the brush head 16 to a base portion 26. The base portion 26 has a cleat 28 with a cutter 30 protruding from an outward surface. The base portion 26 also has an insertable portion 32 having prongs 34 with tabs 36 extending directionally away from the brush head 16. The insertable portion 32 has a smaller diameter than the base portion 26 and includes a recess 33.

The floss dispenser portion 14 has an inner cavity 38 that receives an insertable floss coil 40. The floss coil 40 may be any type of conventional dental floss such as waxed, unwaxed, flavored, or unflavored, and it may be in cross-sectional shape. The floss dispenser portion 14 further includes an aperture 42 that a thread of the floss coil 40 extends through and depressions 44 that have openings 46 operable to receive tabs 36 of prongs 34. The insertable portion 32 is receivable within the inner cavity 38. The base portion 26 has a similar diameter to floss dispenser portion 14. The brush head 16, the longitudinal extension 24, the base portion 26, and the floss dispenser portion 14 are generally manufactured from hard plastic; however, other suitable materials may be used. The floss dispenser portion 14 may be opaque or transparent.

In one cycle of operation of this embodiment, the brush head portion 12 and the floss dispenser portion 14 are initially separated. A user inserts the floss coil 40 into the inner cavity 38 and pulls the thread of the floss coil 40 through aperture 42. The user then inserts the brush head portion 12 into the floss dispenser portion 14 until the tabs are received in openings 46. The thread of floss coil 40 is then wrapped around cleat 28. The user uses the plurality of bristles 20 to brush his teeth. The plurality of outward-angled bristles 22 reaches hard to brush areas of the user's teeth. The user then unwraps the thread of floss coil 40 from the cleat 28 and pulls the thread of floss coil 40 a length appropriate for the user to floss with. The thread of the floss coil 40 is wrapped around the cleat 28 and pulled taught through the keyhole slot 18 of the brush head 16. The user may then wrap the thread of floss coil 40 around a finger and proceed to floss using his finger and the brush head 16. After flossing, the user removes the thread of floss coil 40 from the keyhole slot 18 and uses the cutter 30 to cut the used portion of the floss coil 40. The user rewraps the thread of the floss coil 40 around the cleat 28 to prepare for the next use.

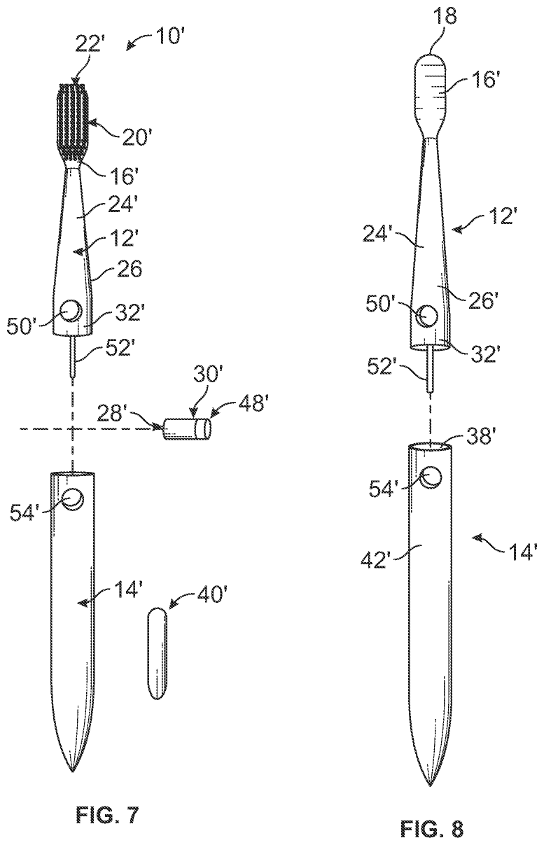

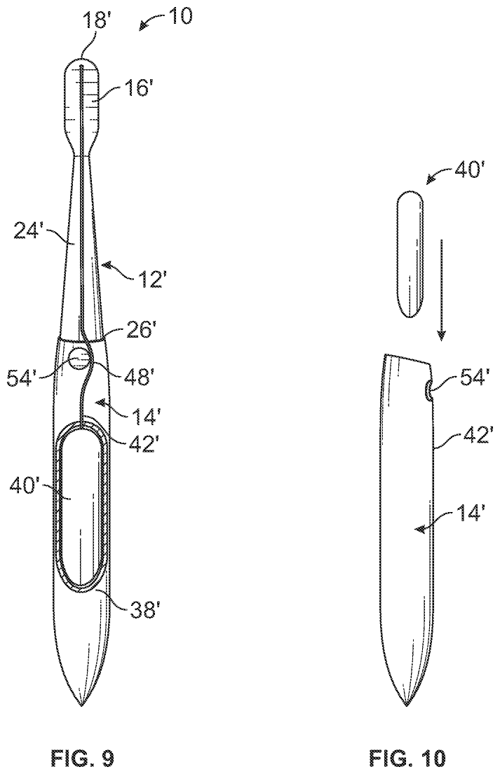

Referring now to FIGS. 7-11, in another embodiment of the present invention, an oral hygiene device 10′ comprises a brush head portion 12′, a floss dispenser portion 14′, and a removable peg 34′ having a cleat 28′ and a cutter 30′. The brush head portion 12′ further includes a brush head 16′ having a keyhole notch 18′ and a plurality of bristles 20′. The plurality of bristles 20′ may be any size, shape, and material conventionally used for cleaning teeth. The brush head 16′ may include other ways to clean teeth, such as scrapers, ultrasonic cleaners, or water jets. The plurality of bristles 20′ has a plurality of outward-angled bristles 22′ angled towards the keyhole slot 18′. The brush head portion 12′ also includes a longitudinal extension 24′ connecting the brush head 16′ to a base portion 26′. The base portion 26′ has an insertable portion 32′ having a smaller diameter than the base portion 26′. The insertable portion 32′ includes an aperture 50′ operable to receive the removable peg 48′. The insertable portion 32′ further includes a floss hook 52′. The brush head 16′, the longitudinal extension 24′, the base portion 26′, and the floss dispenser portion 14′ are generally manufactured from hard plastic; however, other suitable materials may be used. The removable peg 48′ may be a metal, such as stainless steel, or hard plastic, or wood. The floss dispenser portion 14′ may be opaque or transparent.

The floss dispenser portion 14′ has an inner cavity 38′ that receives an insertable floss coil 40′. The floss coil 40′ may be any type of conventional dental floss such as waxed, unwaxed, flavored, or unflavored, and it may be in cross-sectional shape The floss dispenser portion 14′ further includes an aperture 42′ that a thread of the floss coil 40′ extends through, and an aperture 54′ operable to receive the removable peg 48′. The insertable portion 32′ is receivable within the inner cavity 38′. The base portion 26′ has a similar diameter to floss dispenser portion 14′.

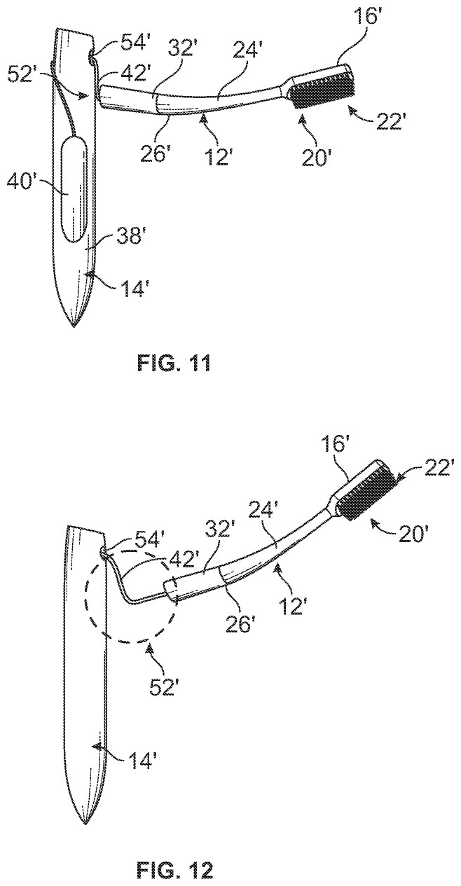

In one cycle of operation of this embodiment, the brush head portion 12′ and the floss dispenser portion 14′ are initially separated. A user inserts the floss coil 40′ into the inner cavity 38′ and pulls the thread of the floss coil 40′ through aperture 42′ using the floss hook 52′ (FIGS. 11, 12). The user then inserts the brush head portion 12′ into the floss dispenser portion 14′ and inserts the removable peg 48′ into both the aperture 50′ and the aperture 54′ to hold the brush head portion 12′ and the floss dispenser portion 14′ together. The thread of floss coil 40′ is then wrapped around cleat 28′. The user uses the plurality of bristles 20′ to brush his teeth. The plurality of outward-angled bristles 22′ reaches hard to brush areas of the user's teeth. The user then unwraps the thread of floss coil 40′ from the cleat 28′ and pulls the thread of floss coil 40′ a length appropriate for the user to floss with. The thread of the floss coil 40′ is wrapped around the cleat 28′ and pulled taught through the keyhole slot 18′ of the brush head 16′. The user may then wrap the thread of floss coil 40′ around a finger and proceed to floss using his finger and the brush head 16′. After flossing, the user removes the thread of floss coil 40′ from the keyhole slot 18′ and uses the cutter 30′ to cut the used portion of the floss coil 40′. The user rewraps the thread of the floss coil 40′ around the cleat 28′ to prepare for the next use.

Specific embodiments of novel apparatus for construction and use of a combination toothbrush and dental floss dispenser according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

I claim:

1. An oral hygiene device comprising:
a brush head portion comprising a brush head having a plurality of bristles and a longitudinal extension connecting the brush head to a base portion, the base portion having an insertable portion, the insertable portion having a smaller diameter than the base portion;
a floss dispenser portion having an inner cavity adapted to receive a supply of floss;
the inner cavity extending through an upper end of the floss dispenser portion, the inner cavity operable to receive the insertable portion;
an aperture proximal the upper end of the floss dispenser portion, the aperture extending through the floss dispenser portion, the aperture creating a passage through which a length of floss may extend.

2. The oral hygiene device of claim 1, the base portion further comprising a cleat having a cutter attached to an outer surface of the base portion.

3. The oral hygiene device of claim 2, the insertable portion further comprising at least one prong having a tab.

4. The oral hygiene device of claim 3, the floss dispenser portion further comprising at least one aperture operable to receive the tab when the insertable portion is removably received in the inner cavity, the tab adapted to release from the aperture when pressure is applied to the tab.

5. The oral hygiene device of claim 4, the at least one aperture located in at least one depression of the floss dispenser portion.

6. The oral hygiene device of claim 5, the brush head further comprising a keyhole slot extending through a surface of the brush head through which the length of floss may extend.

7. The oral hygiene device of claim 6, the plurality of bristles further comprising a plurality of outward-angled bristles angled towards the keyhole slot.

8. The oral hygiene device of claim 1, the insertable portion further comprising an aperture extending through the insertable portion, the aperture adapted to receive a peg having a cleat and a cutter.

9. The oral hygiene device of claim 8, the floss dispenser portion further comprising a second aperture extending through the floss dispenser portion, the second aperture operable to removably receive the peg.

10. The oral hygiene device of claim 9, the brush head further comprising a keyhole slot extending through a surface of the brush head through which the length of floss may extend.

11. The oral hygiene device of claim 6, the plurality of bristles further comprising a plurality of outward-angled bristles angled towards the keyhole slot.

12. The oral hygiene device of claim 9, the insertable portion further comprising a floss hook removably received in the aperture and operable to pull the length of floss through the aperture.

13. A method of providing oral care, comprising:
providing an oral hygiene device, comprising:
a brush head portion comprising a brush head having a plurality of bristles and a longitudinal extension connecting the brush head to a base portion, the base portion having an insertable portion, the insertable portion having a smaller diameter than the base portion;
a floss dispenser portion having an inner cavity adapted to receive a supply of floss;
the inner cavity extending through an upper end of the floss dispenser portion, the inner cavity adapted to receive the insertable portion;
an aperture proximal the upper end of the floss dispenser portion, the aperture extending through the floss dispenser portion to create a passage through which a length of floss may extend;
a cleat having a cutter attached to the oral hygiene device;
a keyhole slot extending through a surface of the brush head through which the length of floss extends;
pulling the length of floss through the aperture;
wrapping the length of floss around the cleat;
pulling the length of floss through the keyhole slot;
creating tension in the length of floss;
wrapping the length of floss around a user's finger;
and flossing.

14. The method of providing oral care of claim 13, further comprising pulling the length of floss against the cutter and cutting the length of floss.
